(19) United States
(12) Patent Application Publication
(10) Pub. No.: US 2025/0197736 A1
(43) Pub. Date: Jun. 19, 2025

(54) USE OF SELECTED RESINS FOR SULFATE REMOVAL IN HYDROCARBON MEDIUMS

(71) Applicant: ECOLAB USA Inc., St. Paul, MN (US)

(72) Inventors: Sidonie PONE, Fulshear, TX (US); Ashish DHAWAN, Aurora, IL (US); Sean KENNEDY, King of Prussia, PA (US)

(73) Assignee: ECOLAB USA Inc., St. Paul, MN (US)

(21) Appl. No.: 18/984,600

(22) Filed: Dec. 17, 2024

Related U.S. Application Data
(60) Provisional application No. 63/611,675, filed on Dec. 18, 2023.

(51) Int. Cl. C10G 25/02; B01D 15/20; B01D 15/36; B01J 41/07; B01J 41/13; B01J 47/02

(52) U.S. Cl. CPC C10G 25/02; B01D 15/20; B01D 15/363; B01J 41/07; B01J 41/13; B01J 47/02; C10G 2400/02; C10G 2400/04; C10G 2400/08

(57) ABSTRACT

The disclosure provides compositions and methods for removing ions from hydrocarbon mediums. A method may include removing a first anion from a liquid hydrocarbon. The method may include contacting an ion exchange resin having a second anion with a water-soluble organic solvent to form a treated ion exchange resin, contacting the treated ion exchange resin with the liquid hydrocarbon, and removing the first anion from the liquid hydrocarbon by exchanging the first anion with the second anion. A composition may include the hydrocarbon medium and the ion exchange resin or treated ion exchange resin.

### TECHNICAL FIELD

The present disclosure generally relates to compositions and methods for the removal of ions from hydrocarbon mediums.

### BACKGROUND

Hydrocarbon mediums may contain a variety of ions, some of which can have harmful effects. For example, sulfates may be found in gasoline or diesel fuel. When the gasoline or diesel fuel is used, the sulfates can reduce the effectiveness of vehicle fuel injection systems, for example, by clogging the retail fuel filters and terminal filters. Therefore, removal of certain ions from hydrocarbon mediums may be beneficial.

### BRIEF SUMMARY

The present disclosure provides compositions and methods for removing ions from hydrocarbon mediums.

In some embodiments, the disclosure provides a method of removing a first anion from a liquid hydrocarbon. The method comprises contacting an ion exchange resin comprising a second anion with a water-soluble organic solvent to form a treated ion exchange resin, contacting the treated ion exchange resin with the liquid hydrocarbon, and removing the first anion from the liquid hydrocarbon by exchanging the first anion with the second anion.

In some embodiments, a composition of the present disclosure comprises a liquid hydrocarbon comprising a first anion, and a treated ion exchange resin comprising a second anion.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, such as from about 4 to about 7 carbon atoms or about 4 to 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C—O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A}) (R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions and methods for removing ions from hydrocarbon mediums. In some embodiments, a liquid hydrocarbon medium comprises a first anion and an ion exchange resin comprises a second anion. Various ion exchange resins may be used in accordance with the presently disclosed technology.

For example, the ion exchange resin may comprise a polymer, such as polystyrene. The polymer of the ion exchange resin may optionally be crosslinked. The ion exchange resin may be a crosslinked strong base anionic resin in some embodiments. In certain aspects, the ion exchange resin may comprise a quaternary ammonium group. An illustrative, non-limiting example of an ion exchange resin that may be used in accordance with the presently disclosed technology is poly[styrene-co-4-vinylbenzyl-trialkylammonium hydroxide-co-divinylbenzene].

As an additional example, the ion exchange resin of the present disclosure may comprise the following formula I:

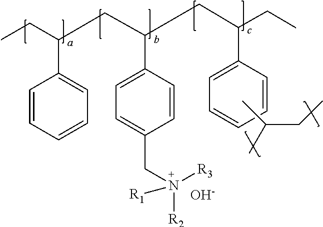

wherein the polymer of the ion exchange resin comprises from about 10 mol % to about 50 mol % of the “a” unit, from about 20 mol % to about 90 mol % of the “b” unit, and from about 1 mol % to about 20 mol % of the “c” unit.

For example, the polymer may comprise from about 10 mol % to about 40 mol %, from about 10 mol % to about 30 mol %, from about 10 mol % to about 20 mol %, from about 20 mol % to about 50 mol %, from about 30 mol % to about 50 mol %, from about 40 mol % to about 50 mol %, or from about 20 mol % to about 40 mol % of the “a” unit.

The polymer may comprise from about 30 mol % to about 90 mol %, from about 40 mol % to about 90 mol %, from about 50 mol % to about 90 mol %, from about 60 mol % to about 90 mol %, from about 70 mol % to about 90 mol %, from about 80 mol % to about 90 mol %, from about 20 mol % to about 80 mol %, from about 20 mol % to about 70 mol %, from about 20 mol % to about 60 mol %, from about 20 mol % to about 50 mol %, from about 20 mol % to about 40 mol %, from about 20 mol % to about 30 mol %, from about 30 mol % to about 80 mol %, from about 40 mol % to about 70 mol %, or from about 50 mol % to about 60 mol % of the “b” unit.

The polymer may comprise from about 5 mol % to about 20 mol %, from about 10 mol % to about 20 mol %, from about 15 mol % to about 20 mol %, from about 1 mol % to about 15 mol %, from about 1 mol % to about 10 mol %, from about 1 mol % to about 5 mol %, from about 5 mol % to about 15 mol %, or from about 10 mol % to about 15 mol % of the “c” unit.

The R₁, R₂, and R₃ groups may be independently selected from alkyl groups, such as a C₁ alkyl group to a C₃₀ alkyl group or even alkyl groups containing more than 30 carbon atoms. For example, each R₁, R₂, R₃ groups may be independently selected from a C₁ to C₃₀ alkyl group, a C to C₂₅ alkyl group, a C₁ to C₂₀ alkyl group, a C₁ to C₁₅ alkyl group, a C₁ to C₅ alkyl group, a C₅ to C₃₀ alkyl group, a C₁₀ to C₃₀ alkyl group, a C₁₅ to C₃₀ alkyl group, a C₁alkyl group, a C₂ alkyl group, a C₃ alkyl group, a C₄ alkyl group, a C₅ alkyl group, a C₆ alkyl group, a C₇ alkyl group, a C₈ alkyl group, a C₉ alkyl group, or a C₁₀ alkyl group.

In some embodiments, the R₁, R₂, and R₃ groups are the same (e.g., each R₁, R₂, and R₃ group is methyl). In other embodiments, one or more of the R₁, R₂, and R₃ groups may be different, such as R₁ and R₂=methyl and R₃=ethyl or R₁=methyl, R₂=ethyl, and R₃=propyl.

Although formula I includes a quaternary ammonium group as a substituent on the phenyl ring in the “b” unit, polymers of the present disclosure may include a variety of other cationic groups as substituents on the phenyl ring of the “b” unit, either in addition to or instead of the quaternary ammonium group. Such cationic groups may be directly bonded to the phenyl ring or they may be linked to the phenyl ring by, for example, a methyl group, ethyl group, propyl group, butyl group, pentyl group, hexyl group, or other alkyl, alkenyl, or alkynyl group.

For example, the cationic group may be a phosphorus-containing group, such as triphenyl phosphonium, trimethyl phosphonium, triethyl phosphonium, tripropyl phosphonium, tributyl phosphonium, trichloro phosphonium, or trifluoro phosphonium. Illustrative, non-limiting examples include:

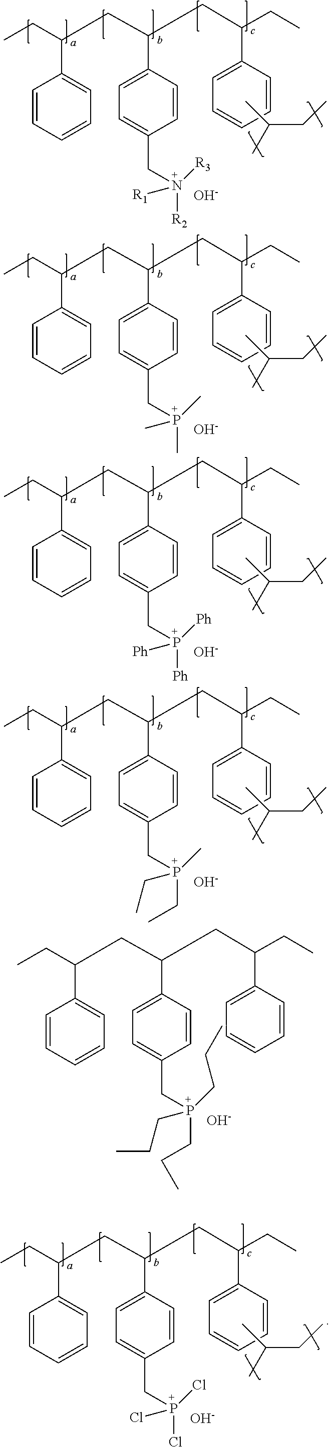

In some embodiments, the cationic group may comprise, for example, pyrrolium, imidazolium, pyrazolium, oxazolium, thiazolium, pyridinium, pyrimidinium, pyrazinium, pyradizinium, thiazinium, morpholinium, piperidinium, piperizinium, or pyrollizinium. Illustrative, non-limiting examples include:

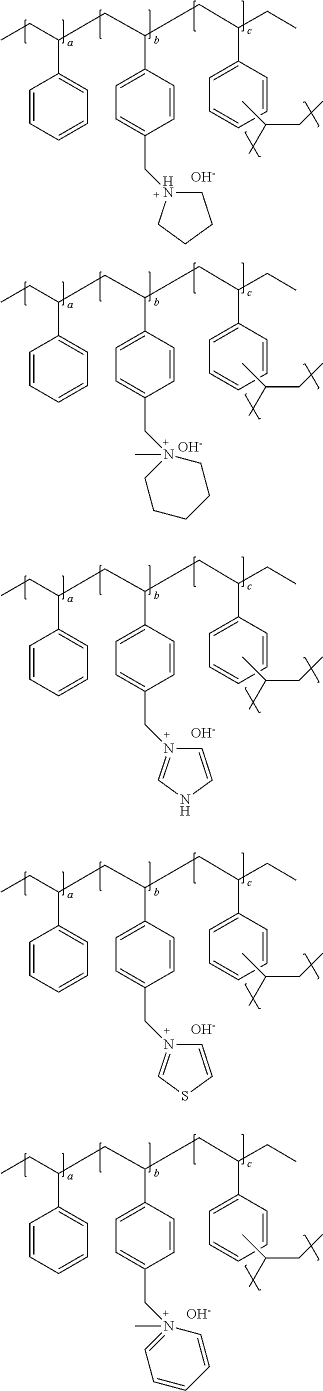

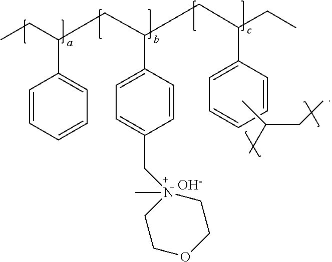

As an additional non-limiting example, the ion exchange resin may be a styrene/divinylbenzene resin containing a quaternary ammonium group or any other cationic group disclosed in the present application.

The ion exchange resins of the present disclosure comprise one or more pores. The diameter of each pore may range from about 1,000 Angstroms to about 500,000 Angstroms. The pores may all have the same or substantially the same diameter or the pores may have different diameters.

In some embodiments, a pore may have a diameter in a range of about 1,000 Angstroms to about 500,000 Angstroms, about 1,000 Angstroms to about 400,000 Angstroms, about 1,000 Angstroms to about 300,000 Angstroms, about 1,000 Angstroms to about 200,000 Angstroms, about 1,000 Angstroms to about 100,000 Angstroms, about 1,000 Angstroms to about 80,000 Angstroms, about 1,000 Angstroms to about 60,000 Angstroms, about 1,000 Angstroms to about 40,000 Angstroms, about 1,000 Angstroms to about 20,000 Angstroms, about 1,000 Angstroms to about 10,000 Angstroms, about 10,000 Angstroms to about 500,000 Angstroms, about 20,000 Angstroms to about 500,000 Angstroms, about 30,000 Angstroms to about 500,000 Angstroms, about 40,000 Angstroms to about 500,000 Angstroms, about 50,000 Angstroms to about 500,000 Angstroms, about 60,000 Angstroms to about 500,000 Angstroms, about 70,000 Angstroms to about 500,000 Angstroms, about 80,000 Angstroms to about 500,000 Angstroms, about 90,000 Angstroms to about 500,000 Angstroms, about 100,000 Angstroms to about 500,000 Angstroms, about 200,000 Angstroms to about 500,000 Angstroms, about 300,000 Angstroms to about 500,000 Angstroms, about 25,000 Angstroms to about 75,000 Angstroms, about 30,000 Angstroms to about 70,000 Angstroms, about 5,000 Angstroms to about 100,000 Angstroms, about 10,000 Angstroms to about 300,000 Angstroms, about 10,000 Angstroms to about 200,000 Angstroms, or about 5,000 Angstroms to about 100,000 Angstroms.

The pore volume of each pore may range from about 0.1 ml/g to about 5 ml/g (dry) or more. The pores may all have the same or substantially the same volume or the pores may have different volumes.

In some embodiments, a pore may have a volume in a range of about 0.36 ml/g to about 4.5 ml/g, about 0.36 ml/g to about 4 ml/g, about 0.36 ml/g to about 3.5 ml/g, about 0.36 ml/g to about 3 ml/g, about 0.36 ml/g to about 2.5 ml/g, about 0.36 ml/g to about 2 ml/g, about 0.36 ml/g to about 1.5 ml/g, about 0.36 ml/g to about 1.3 ml/g, about 0.36 ml/g to about 1.1 ml/g, about 0.36 ml/g to about 1 ml/g, about 0.36 ml/g to about 0.8 ml/g, about 0.36 ml/g to about 0.6 ml/g, about 0.5 ml/g to about 5 ml/g, about 0.75 ml/g to about 5 ml/g, about 1 ml/g to about 5 ml/g, about 1.5 ml/g to about 5 ml/g, about 2 ml/g to about 5 ml/g, about 2.5 ml/g to about 5 ml/g, or about 3 ml/g to about 5 ml/g.

The ion exchange resin may have a crush strength or Chatillon value of about 24 g/bead (710 μm bead diameter) to about 1,000 g/bead (710 μm bead diameter) or more.

In some embodiments, the ion exchange resin may have a crush strength or Chatillon value of about 24 g/bead to about 800 g/bead, about 24 g/bead to about 600 g/bead, about 24 g/bead to about 400 g/bead, about 24 g/bead to about 200 g/bead, about 24 g/bead to about 100 g/bead, about 24 g/bead to about 80 g/bead, about 24 g/bead to about 60 g/bead, about 24 g/bead to about 40 g/bead, about 100 g/bead to about 1,000 g/bead, about 200 g/bead to about 1,000 g/bead, about 300 g/bead to about 1,000 g/bead, about 400 g/bead to about 1,000 g/bead, about 500 g/bead to about 1,000 g/bead, about 750 g/bead to about 1,000 g/bead, or about 175 g/bead to about 475 g/bead.

As mentioned throughout the present disclosure, the ion exchange resin comprises an anion, sometimes referred to herein as a second anion. Illustrative, non-limiting examples of the anion (or second anion) include hydroxide, acetate, formate, citrate, oxalate, an organosulfonate, and any combination thereof. The ion exchange resin may comprise (or exclude) one of the foregoing anions or any combination of the foregoing anions.

In certain applications, resins with anions in the OH⁻ form instead of the Cl⁻ form may be preferred, for example, so that chlorides are not introduced into the hydrocarbon medium (e.g., gasoline). Thus, in some embodiments, the anion (or second anion) excludes chloride.

Certain examples of ion exchange resins that can be used in accordance with the presently disclosed technology include, but are not limited to, Purolite A500OHPlus, which is a polystyrenic macroporous, Type I strong base anion resin, hydroxide form, and Purolite A510MBOHPlus, which is a polystyrenic macroporous, Type II strong base anion resin, hydroxide form, mixed bed grade.

The ion exchange resins of the present disclosure may be used in methods for removing ions from hydrocarbon mediums. For example, a method of removing a first anion from a liquid hydrocarbon is disclosed herein. The method comprises contacting an ion exchange resin comprising a second anion with a water-soluble organic solvent to form a treated ion exchange resin, contacting the treated ion exchange resin with the liquid hydrocarbon, and removing the first anion from the liquid hydrocarbon by exchanging the first anion with the second anion.

When forming the treated ion exchange resin by contacting an ion exchange resin with a water-soluble organic solvent, the contacting may be carried out by any means known in the art and for any desired amount of time. For example, the ion exchange resin may be soaked/submerged in the water-soluble organic solvent and then removed from the solvent prior to use.

This step may be carried out for any period of time, such as from about 1 hour to about 48 hours, about 1 hour to about 40 hours, about 1 hour to about 30 hours, about 1 hour to about 20 hours, about 1 hour to about 10 hours, about 5 hours to about 48 hours, about 10 hours to about 48 hours, about 20 hours to about 48 hours, about 30 hours to about 40 hours, or about 12 hours to about 24 hours.

Treating the resin with the solvent before contacting the resin with the hydrocarbon medium facilitates increased interaction of the resin ionic groups with the hydrocarbon medium. Commercially available resins, such as strong base anionic resins, have a high amount of moisture retention in their pores (up to about 65 wt. %). The present inventors determined that carrying out anion exchange using the resin beads with water in their pores slows down the rate of diffusion and permits anion exchange only at the outer surface of the resin beads. In addition, the absence of swelling of resin beads (due to incompatibility of the medium (e.g., gasoline) with water) reduces the diffusion rate of the medium, such as gasoline, prevents it from reaching ionic groups present inside of beads. Accordingly, the resin beads of the present disclosure are treated with a water-soluble organic solvent so that water from the pores can be displaced with the organic solvent before the resins are used in methods of removing ions from hydrocarbon mediums.

Once the resin has been sufficiently treated/contacted with the solvent for the desired amount of time, it may be removed from the solvent (e.g., the solvent may be drained therefrom) and the resin may be used in a method of the present disclosure. For example, the treated ion exchange resin may be added to a vessel, such as an open-ended column, and the liquid hydrocarbon may be passed through the vessel comprising the treated ion exchange resin. In some embodiments, a vessel may comprise a packed bed of the treated ion exchange resin. In certain embodiments, a method of the present disclosure may comprise mixing the liquid hydrocarbon with the treated ion exchange resin in a batch process.

In any case, when the liquid hydrocarbon comprising a first anion contacts the ion exchange resin comprising the second anion, the ions may be exchanged such that after a period of time (e.g., a few seconds to a few minutes), the ion exchange resin comprises the first anion meaning that the first anion has been removed from the liquid hydrocarbon medium. In turn, the liquid hydrocarbon medium may subsequently comprise the second anion.

In an illustrative example, a treated strong base anionic resin is contacted with diesel or gasoline for sulfate removal via anion exchange (OH⁻ to SO₄²⁻). The scheme below depicts the anion exchange reaction.

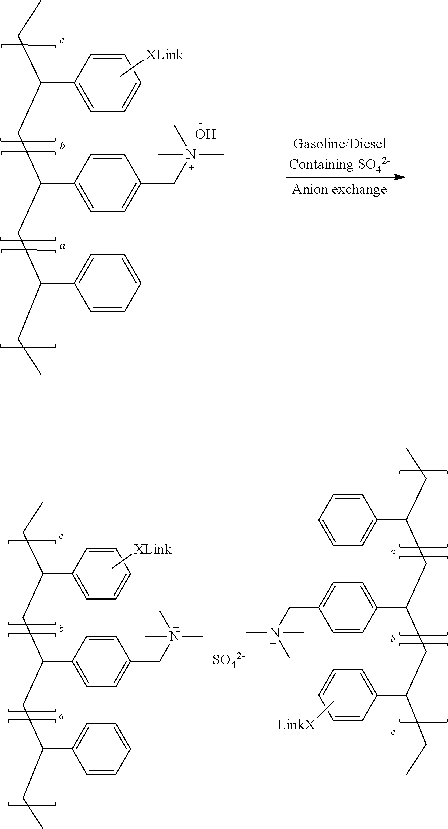

Various water-soluble solvents may be used to contact/pre-treat the ion exchange resin. For example, the water-soluble organic solvent may be selected from acetone, an alcohol (e.g., methanol, ethanol, propanol, 2-butoxylethanol, 1,3-propandiol, a glycol, etc.), tetrahydrofuran, acetonitrile, dimethylformamide, N-methyl pyrrolidone, and any combination thereof.

The liquid hydrocarbon to be treated by the methods of the present disclosure is not particularly limited. Illustrative, non-limiting examples include gasoline, gasoline comprising ethanol, premium unleaded CARBOB, diesel, alkylate, kerosene, and any combination thereof.

During the process of treating the liquid hydrocarbon with the ion exchange resin, various ions may be removed from the liquid hydrocarbon medium. For example, the medium may comprise a sulfate, a sulfite, a chloride, and any combination thereof.

The foregoing may be better understood by reference to the following examples, which are intended for illustrative purposes and are not intended to limit the scope of the disclosure or its application in any way.

### EXAMPLES

In a first set of experiments, various resins (see Table 1) were added to a measuring cylinder up to around the 40 mL mark. Acetone was then added to the measuring cylinder up to around the 100 mL mark. The resin was soaked in the acetone for about 24 hours. The contents of the cylinder were then filtered to remove the acetone. Gasoline was then added to the treated resin and the resulting mixture was shaken for about 24 hours. The gasoline was then separated from the resin and the sulfate concentration of the gasoline was measured. Results are shown in Table 2.

TABLE 1

| Sample | | |
|---|---|---|
| ID | Resin used | Treatment |
| Sample | Untreated | |
| 1 | | |
| Sample | A500OHPlus | Resin soaked in acetone for ~24 h then |
| 2 | | soaked with gasoline on the shaker for |
| | | 24 h |
| Sample | A510MBOHPlus | Resin soaked in acetone for ~24 h then |
| 3 | | soaked with gasoline on the shaker |
| | | for ~24 h |
| Sample | A500OHPlus | Resin soaked in gasoline for 7 days. |
| 4 | | |

TABLE 2

| Samples Name | Sulfate content (ppmw) |
|---|---|
| Sample 1 | 0.06 |
| Sample 2 | 0.04 |
| Sample 3 | <0.02 |
| Sample 4 | <0.02 |

In a second set of experiments, gasoline samples were passed through a packed bed of strong base anionic resins (see Table 3) in a column. The flow rate was about 2 mL/min. Resin samples #7 and #8 were soaked in the acetone for approximately 24 hours before being loaded in the glass column. After passing through the packed bed, the sulfate concentration of the gasoline was measured. Results are shown in Table 4.

TABLE 3

| Sample ID | Resin used | Acetone soaked/treated |
|---|---|---|
| Sample 5 | A500OHPlus | No |
| Sample 6 | A510MBOHPlus | No |
| Sample 7 | A500OHPlus | Yes |
| Sample 8 | A510MBOHPlus | Yes |

TABLE 4

| Sample Name | Sulfate content (ppmw) |
|---|---|
| Untreated Sample | 0.24 |
| Sample 5 | 0.14 |
| Sample 6 | 0.09 |
| Sample 7 | 0.05 |
| Sample 8 | 0.05 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a solvent” is intended to include “at least one solvent” or “one or more solvents.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of removing a first anion from a liquid hydrocarbon, comprising:
contacting an ion exchange resin comprising a second anion with a water-soluble organic solvent to form a treated ion exchange resin,
contacting the treated ion exchange resin with the liquid hydrocarbon, and
removing the first anion from the liquid hydrocarbon by exchanging the first anion with the second anion.

2. The method of claim 1, further comprising soaking the ion exchange resin in the water-soluble organic solvent for about 1 hour to about 48 hours.

3. The method of claim 1, further comprising flowing the liquid hydrocarbon through a vessel comprising the treated ion exchange resin.

4. The method of claim 3, wherein the vessel comprises a packed bed of the treated ion exchange resin.

5. The method of claim 1, further comprising mixing the liquid hydrocarbon with the treated ion exchange resin in a batch process.

6. The method of claim 1, wherein the water-soluble organic solvent is selected from the group consisting of acetone, an alcohol, tetrahydrofuran, acetonitrile, dimethylformamide, N-methyl pyrrolidone, and any combination thereof.

7. The method of claim 1, wherein the liquid hydrocarbon is selected from the group consisting of gasoline, diesel, alkylate, kerosene, and any combination thereof.

8. The method of claim 1, wherein the first anion is selected from the group consisting of a sulfate, a sulfite, a chloride, and any combination thereof.

9. The method of claim 1, wherein the second anion is selected from the group consisting of hydroxide, acetate, formate, citrate, oxalate, an organosulfonate, and any combination thereof.

10. The method of claim 1, wherein the second anion excludes chloride.

11. The method of claim 1, wherein the ion exchange resin comprises a polystyrene.

12. The method of claim 11, wherein the polystyrene is crosslinked.

13. The method of claim 1, wherein the ion exchange resin comprises a cationic group selected from the group consisting of a quaternary ammonium group, a triphenyl phosphonium group, a trimethyl phosphonium group, a triethyl phosphonium group, a tripropyl phosphonium group, a tributyl phosphonium group, a trichloro phosphonium group, a trifluoro phosphonium group, a pyrrolium group, an imidazolium group, a pyrazolium group, an oxazolium group, a thiazolium group, a pyridinium group, a pyrimidinium group, a pyrazinium group, a pyradizinium group, a thiazinium group, a morpholinium group, a piperidinium group, a piperizinium group, a pyrollizinium, and any combination thereof.

14. The method of claim 1, wherein the ion exchange resin comprises poly[styrene-co-4-vinylbenzyl-trialkylammonium hydroxide-co-divinylbenzene].

15. The method of claim 1, wherein the ion exchange resin comprises a polymer having the following formula I: 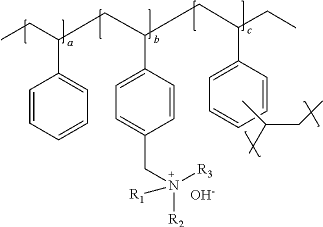
wherein the polymer comprises from about 10 mol % to about 50 mol % of the “a” unit, from about 20 mol % to about 90 mol % of the “b” unit, and from about 1 mol % to about 20 mol % of the “c” unit; and
wherein each R₁, R₂, and R₃ group may be independently selected from an alkyl group.

16. The method of claim 1, wherein the ion exchange resin is a styrene/divinylbenzene resin containing a quaternary ammonium group.

17. The method of claim 1, wherein the ion exchange resin comprises a pore.

18. A composition, comprising:
a liquid hydrocarbon comprising a first anion, and
an ion exchange resin comprising a second anion.

19. The composition of claim 18, wherein the ion exchange resin was contacted with a water-soluble organic solvent prior to formation of the composition.

20. The composition of claim 18, wherein the ion exchange resin comprises the first anion.
